(19) United States
(12) Patent Application Publication
(10) Pub. No.: US 2025/0166357 A1
(43) Pub. Date: May 22, 2025

(54) SEGMENTATION MODEL TRAINING METHOD, DEVICE, AND NON-TRANSITORY COMPUTER READABLE STORAGE MEDIUM

(71) Applicants: Inventec (Pudong) Technology Corporation, Shanghai (CN); INVENTEC CORPORATION, TAIPEI CITY (TW)

(72) Inventors: Shang-Jui KUO, TAIPEI CITY (TW); Po-Han HUANG, TAIPEI CITY (TW); Chia-Ching LIN, TAIPEI CITY (TW); Jeng-Lin LI, TAIPEI CITY (TW); Ming-Ching CHANG, TAIPEI CITY (TW); Wei-Chao CHEN, TAIPEI CITY (TW)

(21) Appl. No.: 18/418,329

(22) Filed: Jan. 21, 2024

(30) Foreign Application Priority Data
Nov. 16, 2023 (CN) 202311532180.3

(51) Int. Cl. G06V 10/774; G06V 10/26

(52) U.S. Cl. CPC G06V 10/774; G06V 10/26

(57) ABSTRACT

A segmentation model training method is disclosed. The segmentation model includes the following operations: inputting several first sample groups of a large sample set to a data augmentation model to generate several augmentation sample groups; generating several mix sample groups based on several second sample groups of a small sample set; inputting several mix sample groups to the data augmentation model to generate several augmentation mix sample groups; and training a segmentation model according to several augmentation sample groups and several augmentation mix sample groups, including: performing pre-training to the segmentation model according to several augmentation sample groups; and performing fine-tuning training to the segmentation model corresponding to several augmentation mix sample groups.

### CROSS-REFERENCE TO RELATED APPLICATION

This application claims the priority benefit of China Application Serial Number CN202311532180.3, filed Nov. 16, 2023, the full disclosure of which is incorporated herein by reference.

### FIELD OF INVENTION

The present application relates to a segmentation model training method, a segmentation model training method, and a non-transitory computer readable storage medium. More particularly, the present application relates to a segmentation model training device, a segmentation model training method, and a non-transitory computer readable storage medium with deep neural network (deep learning).

### BACKGROUND

In recent years, in the field of machine learning, segmentation models have been trained to automatically segment specific areas in an image. The training of segmentation model can be applied to different fields. For example, in the medical field, accurate image segmentation of special patterns (such as wounds or lesions) on human skin plays a key role in skin-related care and diagnosis in the medical field. Automatic segmentation technology has made great progress through deep neural network (DNN). However, since the acquisition and annotation of medical images takes a lot of time, the current training challenge of the segmentation model is that the number of samples is insufficient and the training can be performed only with limited samples, which results in a decrease in performance.

Therefore, how to train a segmentation model when the number of samples is limited is one of the problems to be solved in this field.

### SUMMARY

The disclosure provides a segmentation model training method. The segmentation model includes the following operations: inputting several first sample groups of a large sample set to a data augmentation model to generate several augmentation sample groups; generating several mix sample groups based on several second sample groups of a small sample set; inputting several mix sample groups to the data augmentation model to generate several augmentation mix sample groups; and training a segmentation model according to several augmentation sample groups and several augmentation mix sample groups, including: performing pre-training to the segmentation model according to several augmentation sample groups; and performing fine-tuning training to the segmentation model corresponding to several augmentation mix sample groups.

The disclosure provides a segmentation model training device. The segmentation model training device includes a memory and a processor. The memory is configured to store a segmentation model and a data augmentation model. The processor is coupled to the memory. The processor is configured to perform the following operations: inputting several first sample groups of a large sample set to a data augmentation model to generate several augmentation sample groups; generating several mix sample groups based on several second sample groups of a small sample set; inputting several mix sample groups to the data augmentation model to generate several augmentation mix sample groups; and training the segmentation model according to several augmentation sample groups and several augmentation mix sample groups, including, including: performing pre-training to the segmentation model according to several augmentation sample groups; and performing fine-tuning training to the segmentation model corresponding to several augmentation mix sample groups.

The disclosure provides a non-transitory computer readable storage medium. The non-transitory computer readable storage medium is configured to store a computer program, wherein when the computer program is executed, one or more processors are executed to perform several operations, wherein several operations include: inputting several first sample groups of a large sample set to a data augmentation model to generate several augmentation sample groups; generating several mix sample groups based on several second sample groups of a small sample set; inputting several mix sample groups to the data augmentation model to generate several augmentation mix sample groups; and training a segmentation model according to several augmentation sample groups and several augmentation mix sample groups, including: performing pre-training to the segmentation model according to several augmentation sample groups; and performing fine-tuning training to the segmentation model corresponding to several augmentation mix sample groups.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating a segmentation model training device in accordance with some embodiments of the disclosure.

FIG. 2 is a schematic diagram illustrating a segmentation model training method in accordance with some embodiments of the disclosure.

FIG. 3 is a schematic diagram illustrating an operation of FIG. 2 in accordance with some embodiments of the disclosure.

FIG. 4A is a schematic diagram illustrating an image of the sample groups in accordance with some embodiments of the disclosure.

FIG. 4B is a schematic diagram illustrating an augmentation image of the augmentation sample groups in accordance with some embodiments of the disclosure.

FIG. 5 is a flow chart illustrating an operation of FIG. 2 in accordance with some embodiments of the disclosure.

FIG. 6 is a schematic diagram illustrating a small sample set in accordance with some embodiments of the disclosure.

FIG. 7 is a schematic diagram illustrating the capturing of the target image in accordance with some embodiments of the disclosure.

FIG. 8 is a schematic diagram illustrating a target sample set in accordance with some embodiments of the disclosure.

FIG. 9 is a schematic diagram illustrating an obtaining method of the target area in accordance with some embodiments of the disclosure.

FIG. 10 is a schematic diagram illustrating a mix sample group in accordance with some embodiments of the disclosure.

FIG. 11 is a schematic diagram illustrating an operation of FIG. 2 in accordance with some embodiments of the disclosure.

FIG. 12 is a schematic diagram illustrating an operation of FIG. 2 in accordance with some embodiments of the disclosure.

### DETAILED DESCRIPTION

The following disclosure provides many different embodiments or illustrations for implementing various features of the invention. The components and configurations of the specific examples are used to simplify the embodiments in the following discussion. Any examples discussed are for illustrative purposes only and do not in any way limit the scope and meaning of the embodiments of the present disclosure or its examples.

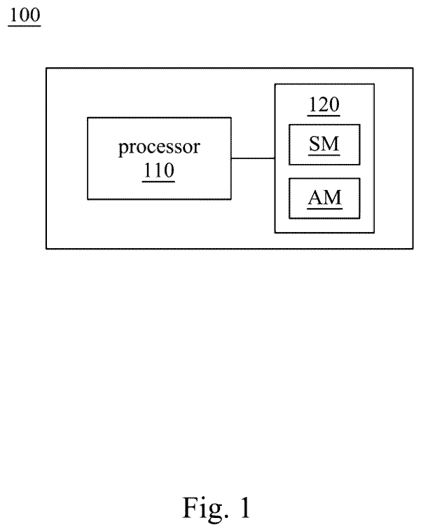

Reference is made to FIG. 1. FIG. 1 is a schematic diagram illustrating a segmentation model training device 100 in accordance with some embodiments of the disclosure. In some embodiments, the segmentation model training device 100 includes a processor 110 and a memory 120. In the connection relationship, the processor 110 is coupled to the memory 120.

The segmentation model training device 100 as illustrated in FIG. 1 is for illustrative purposes only, and the embodiments of the present disclosure are not limited to FIG. 1. The segmentation model training device 100 may further include other elements required for the operations and applications, for example, the segmentation model training device 100 may further include an output interface (for example, a display panel for displaying information), an input interface (for example, a touch panel, a keyboard, a microphone, a scanner or a flash memory reader) and a communication circuit (for example, a Wi-Fi communication model, a Bluetooth communication model, a wireless telecommunications network communication model, etc.). In some embodiments, the segmentation model training device 100 can be created by a computer, a server or a processing center.

In some embodiments, the memory 120 can be a flash memory, an HDD, an SSD (solid state drive), a DRAM (dynamic random-access memory) or an SRAM (static random-access memory). In some embodiments, the memory 120 may be a non-transitory computer readable storage medium storing at least one instruction associated with the segmentation model training method. The processor 110 can access and execute at least one instruction.

In some embodiments, the processor 110 can be, but is not limited to, a single processor or a collection of several micro-processors, such as a CPU or a GPU. The microprocessor is electrically coupled to the memory 120 to access and execute the segmentation model training method according to at least one instruction. For ease of understanding and explanation, the details of the segmentation model training method will be described in the following paragraphs.

In some embodiments, the memory 120 stores the segmentation model SM and the data augmentation model AM. The segmentation model SM and the data augmentation model AM can be read and executed by the processor 110.

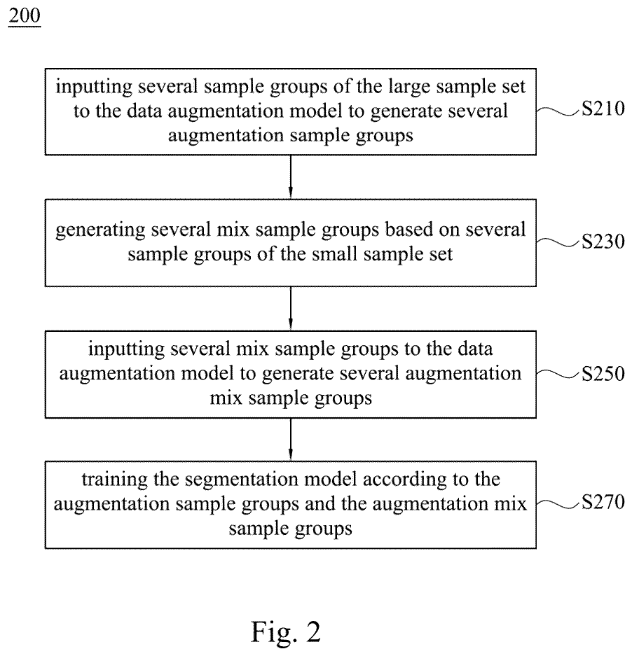

Details of the embodiments of the present disclosure are disclosed below with reference to the segmentation model training method 200 in FIG. 2. The segmentation model training method 200 as illustrated in FIG. 2 is applicable to the segmentation model training device 100 in FIG. 1. However, the embodiments of the present disclosure are not limited thereto.

Reference is made to FIG. 2. FIG. 2 is a schematic diagram illustrating a segmentation model training method 200 in accordance with some embodiments of the disclosure. However, the embodiments of the present disclosure are not limited thereto.

It should be noted that, the segmentation model training method can be applied to a system with the same or similar structure as the segmentation model training device 100 in FIG. 1. To simplify the description, FIG. 1 will be used as an example to describe the segmentation model training method 200. However, the embodiments of the present disclosure are not limited to the application of FIG. 1.

It should be noted that, in some embodiments, the segmentation model training method can also be implemented as a computer program and can be stored in a non-transitory computer-readable recording medium, so that a computer, an electronic device, or the aforementioned processor 110 in FIG. 1 can read the recording medium to perform the operations. The non-transitory computer readable storage medium can be a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

In addition, it should be understood that the operations of the operation methods mentioned in the embodiments, unless the order is specifically stated, can be adjusted according to actual needs, and can even be executed simultaneously or partially simultaneously.

Furthermore, in different embodiments, these operations can also be adaptively added, replaced, and/or omitted.

Reference is made to FIG. 2 again. The segmentation model training method 200 includes the following operations. For the sake of convenience and clear explanation, the detailed operation of the segmentation model training method 200 shown in FIG. 2 is explained below with the operating relationship between the components of the segmentation model training device 100 as illustrated in FIG. 1 with reference to FIG. 1 and FIG. 2 at the same time.

In operation S210, several sample groups of the large sample set are input to the data augmentation model to generate several augmentation sample groups. In some embodiments, operation S210 is performed by the processor 110 as illustrated in FIG. 1.

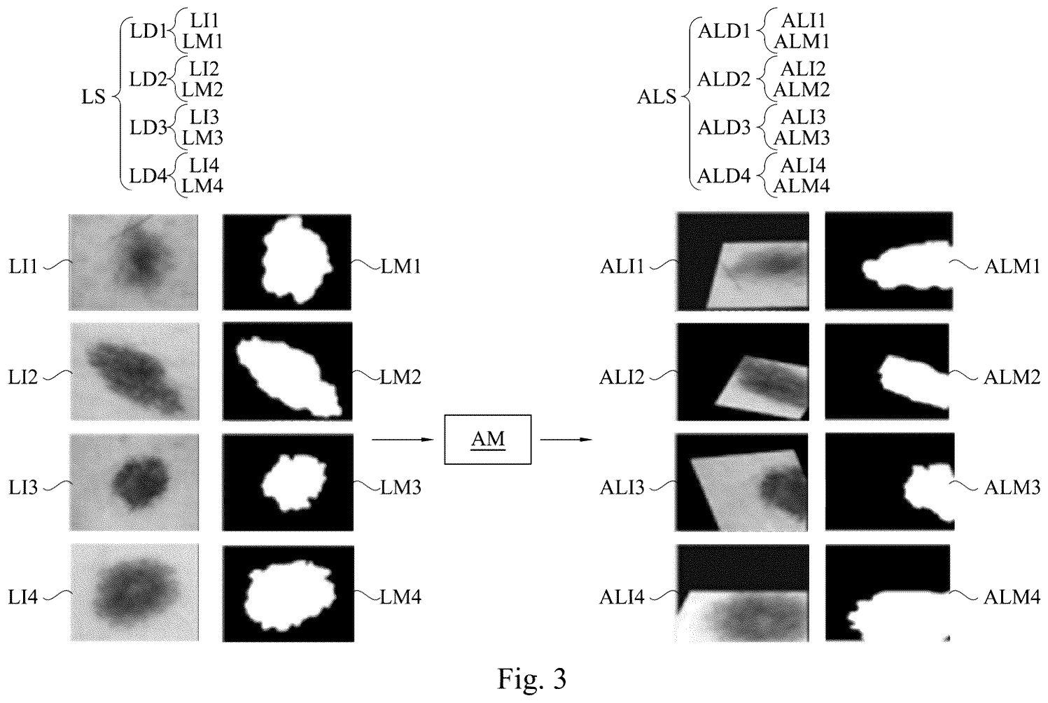

Reference is made to FIG. 3 together. FIG. 3 is a schematic diagram illustrating the operation S210 of FIG. 2 in accordance with some embodiments of the disclosure.

As illustrated in FIG. 3, in operation S210, large sample set LS includes several sample groups LD1 to LD4. Each of the sample groups LD1 to LD4 includes an image and a mask corresponding to the image. For example, the sample group LD1 includes the image LI1 and the mask LM1 corresponding to the image LI1, the sample group LD2 includes the image LI2 and the mask LM2 corresponding to the image LI2, and so on. For the part of image LI2 that includes the wound, the mask LM2 corresponding to the white part with pixels of 1, while for the other part of the image LI2 (that is, the part that does not include the wound), the mask LM2 corresponds to the black part with the pixel of 0.

In some embodiments, after the processor 110 inputs the large sample set LS to the data augmentation model AM as shown in FIG. 1, the augmentation sample set ALS is generated. The augmentation sample set ALS includes several augmentation sample groups ALD1 to ALD4. Each of the augmentation sample groups ALD1 to ALD4 includes an augmentation image and an augmentation mask corresponding to the augmentation image. For example, the augmentation sample group ALD1 includes an augmentation image ALI1 and an augmentation mask ALM1 corresponding to the augmentation image ALI1, the augmentation sample group ALD2 includes an augmentation image ALI2 and an augmentation mask ALM2 corresponding to the augmentation image ALI2, and so on.

In some embodiments, the data augmentation model AM adjusts at least one of a size, an angle (including a rotation angle), a color and a position of images LI1 to LI4 in sample groups LD1 to LD4, to generate the augmentation images ALI1 to ALI4 of the augmentation sample groups ALD1 to ALD4. The data augmentation model AM further adjusts the masks LM1 to LM4 of the sample groups LD1 to LD4 in correspondence, to generate the augmentation masks ALM1 to ALM4 of the augmentation sample groups ALD1 to ALD4.

For example, in an embodiment, the processor 110 rotates the image LI1 of the sample group LD1 45 degrees clockwise to generate the augmentation image ALI1 of the sample group ALD1. Accordingly, the processor 110 correspondingly rotates the mask LM1 of the sample group LD1 45 degrees clockwise to generate the augmentation mask ALM1 of the sample group ALD1. That is, when the image LI1 of the sample group LD1 is adjusted according to the adjusting parameter P1 (not shown) and the augmentation image ALI1 of the sample group ALD1 is produced, the mask LM1 of the sample group LD1 is adjusted according to the same adjusting parameter P1, and the augmentation mask ALM1 of the augmentation sample group ALD1 is produced.

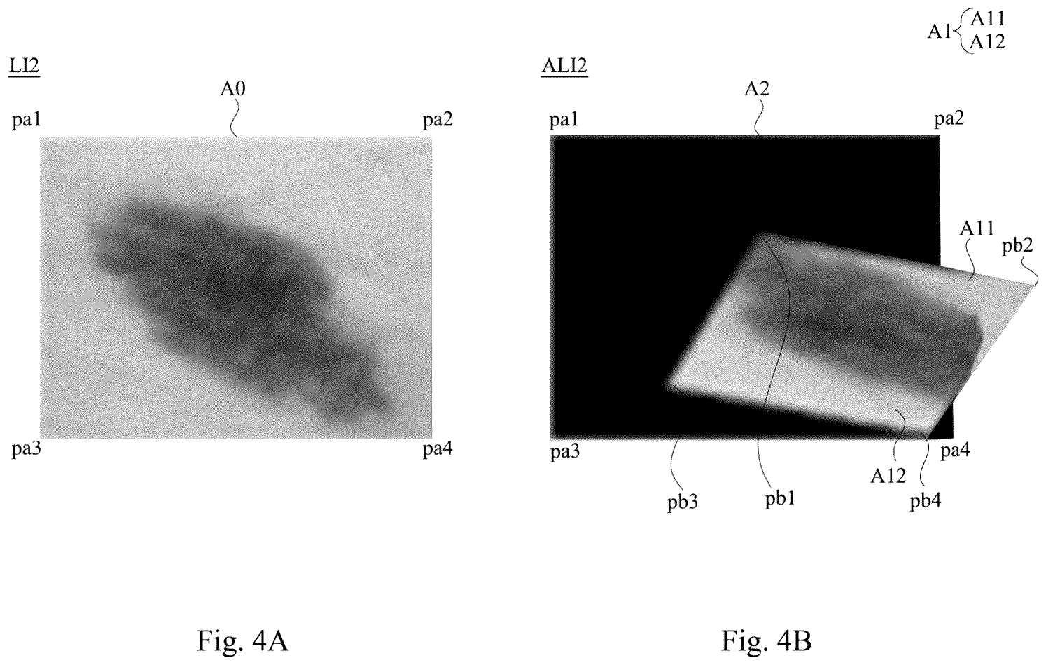

Reference is made to FIG. 4A and FIG. 4B together. FIG. 4A is a schematic diagram illustrating an image L12 of the sample group LD2 in accordance with some embodiments of the disclosure. FIG. 4B is a schematic diagram illustrating an augmentation image ALD2 of the augmentation sample group ALI2 in accordance with some embodiments of the disclosure.

As illustrated in FIG. 4A and FIG. 4B, in an embodiment, after the data augmentation model AM rotates and shifts the image LI2 of the sample group LD2, the image LI2 is moved from the area A0 defined by the original anchor points pa1, pa2, pa3, and pa4 to the area A1 defined by the anchor points pb1, pb2, pb3, and pb4. In the embodiment of the present disclosure, the processor 110 deletes the part of the image beyond the area A0 (that is, the part of area A11), and only the part of the image that falls in area A12 is remained. In addition, the processor 110 fills the area A2 (that is, the part of the area A1 minus the area A12) with black, for example, the processor 110 fills the area A2 with a pixel value of 0. Finally, the processor 110 produces the augmentation image ALI2 of the augmentation sample group ALD2 according to the area A12 and the area A2.

Regarding the generation method of the augmentation mask ALM2 of the augmentation sample group ALD2 is the same as the generation method of the augmentation image ALI2 and will not be described in detail here.

It should be noted that, the sample groups LD1 to LD4 and the augmentation sample groups ALD1 to ALD4 illustrated in FIG. 3 are for illustration only, more sample groups and augmentation sample groups are within the embodiments of the present disclosure. In addition, a sample group can be adjusted differently to produce several augmentation sample groups.

In this way, through the data augmentation model AM, the diversity of the large sample set LS can be increased.

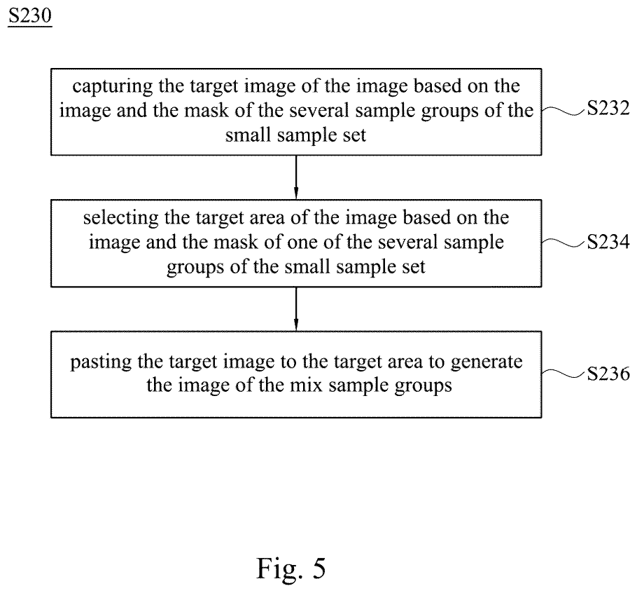

Reference is made to FIG. 2 again. In operation S230, generating several mix sample groups based on several sample groups of the small sample set. In some embodiments, operation S230 is performed by the processor 110 as illustrated in FIG. 1. The detailed implementation of operation S230 will be explained below with reference to FIG. 5.

Reference is made to FIG. 5. FIG. 5 is a flow chart illustrating the operation S230 of FIG. 2 in accordance with some embodiments of the disclosure. Operation S230 includes operations S232 to S236.

In operation S232, capturing the target image of the image based on the image and the mask of the several sample groups of the small sample set.

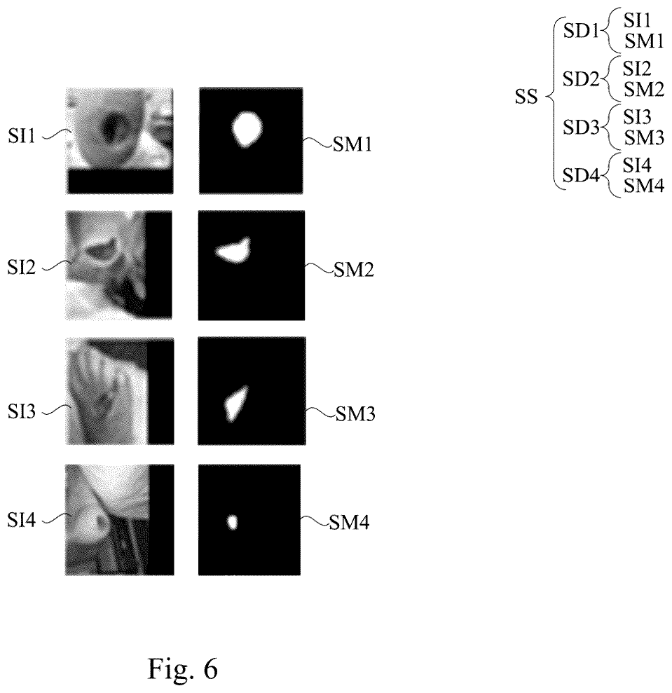

Reference is made to FIG. 6 together. FIG. 6 is a schematic diagram illustrating a small sample set SS in accordance with some embodiments of the disclosure. As illustrated in FIG. 6, the small sample set SS includes the several sample group SD1 to SD4. Each of the sample group SD1 to SD4 includes the image and the mask corresponding to the image. For example, the sample group SD1 includes the image SI1 and the mask SM1 corresponding to the image SI1, the sample group SD2 includes the image SI2 and the mask SM2 corresponding to the image SI2, and so on.

In some embodiments, the processor 110 in FIG. 1 captures the target image from the image based on the image and the mask of the sample group. For example, in an embodiment, the processor 110 captures the target image from the image SI1 based on the image SI1 of the sample group SD1 and the mask SM1 corresponding to the image SI1.

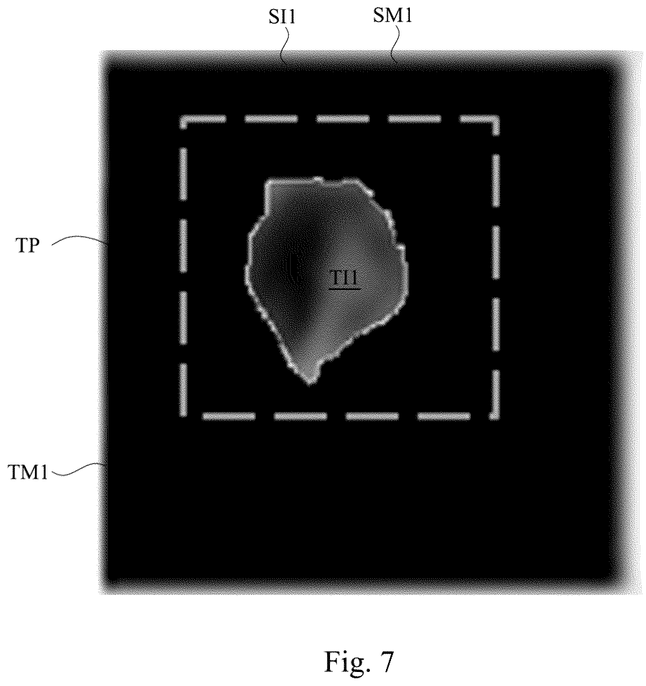

Reference is made to FIG. 7. FIG. 7 is a schematic diagram illustrating the capturing of the target image in accordance with some embodiments of the disclosure. In an embodiment, the processor 110 in FIG. 1 overlaps the image SI1 and the mask SM1 to obtain the target image TI1. In detail, the mask SM1 includes the white part with pixel 1 and the black part with pixel 0. The part of the image SI1 that overlaps the white part with pixel 1 of the mask SM1 is the captured target image TI1. In some embodiments, the processor 110 removes the part of the image SI1 which is not captured to remove the background. That is, the part of the image SI1 which is not captured is filled with pixels 0.

In an embodiment, the processor 110 further captures part of the area TP from the mask SM1 to obtain the mask TM1 corresponding to target image TI1 according to the target image TI1. The mask TM1 captured by the processor 110 includes the white part of the mask SM1 in which the original 5pixel is 1.

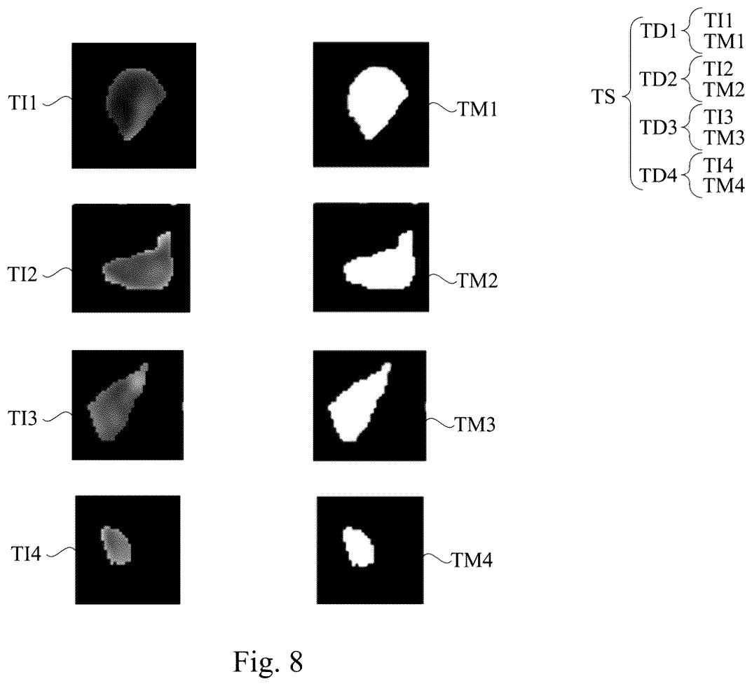

Reference is made to FIG. 8. FIG. 8 is a schematic diagram illustrating a target sample set TS in accordance with some embodiments of the disclosure. The target sample set TS in FIG. 8 includes several target sample groups TD1 to TD4. Each of the target sample group TD1 to TD4 includes the target image and the mask corresponding to the target image. For example, the target sample group TD1 includes the target image TI1 and the mask TM1 corresponding to the target image TI1, the target sample group TD2 includes the target image TI2 and the mask TM2 corresponding to the target image TI1, and so on.

Reference is made to FIG. 5 again. In operation S234, the target area of the image is selected based on the image and the mask of one of the several sample groups of the small sample set.

Reference is made to FIG. 6 and FIG. 8 together. In an embodiment, the processor 110 in FIG. 1 selects one of several sample groups SD1 to SD4 in FIG. 6, and the processor 110 obtains the target area according to the image of one of the selected several sample groups SD1 to SD4.

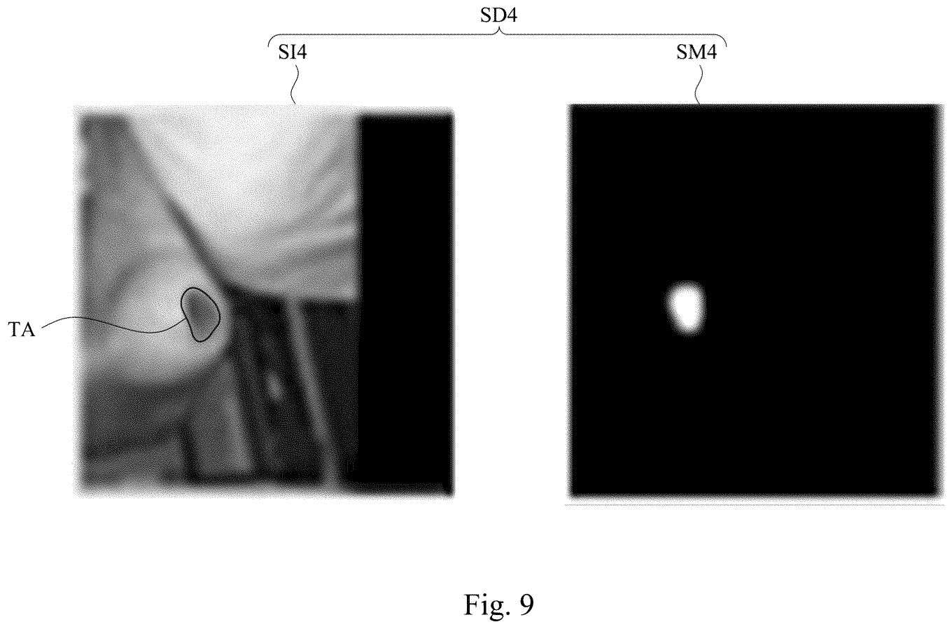

Reference is made to FIG. 9 together. FIG. 9 is a schematic diagram illustrating an obtaining method of the target area in accordance with some embodiments of the disclosure. As illustrated in FIG. 9, in an embodiment, the processor 110 in FIG. 1 selects one of several sample groups SD1 to SD4 in FIG. 6, and the processor 110 obtains the target area according to the image of one of the selected several sample groups SD1 to SD4. In some embodiments, the target area TA is the area of the white part with the pixel of 1 within the mask SM1 when overlapping the image SI4 and the mask SM4.

Reference is made to FIG. 5 again. In operation S236, the target image is pasted to the target area to generate the image of the mix sample groups.

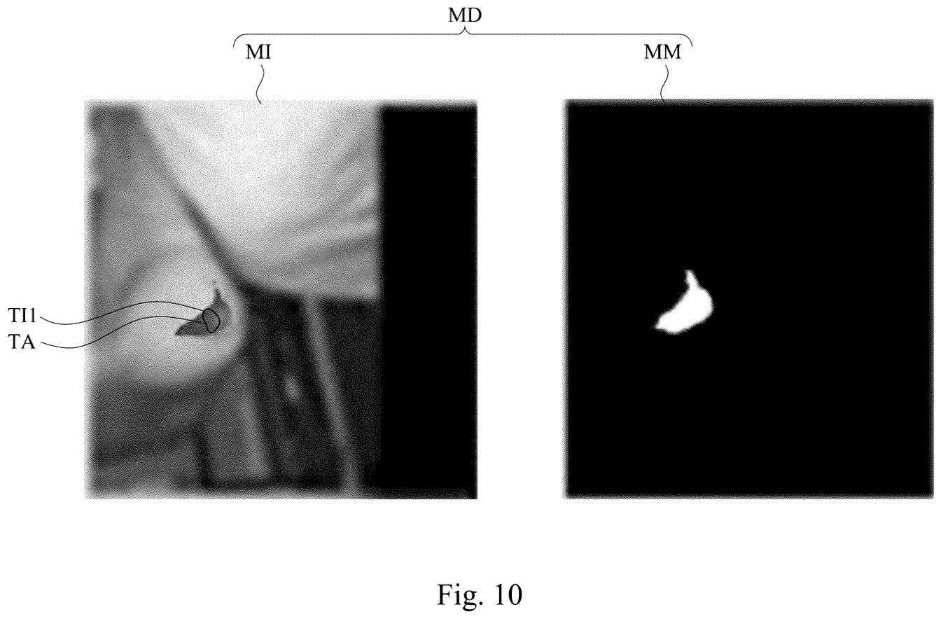

Reference is made to FIG. 10 together. FIG. 10 is a schematic diagram illustrating a mix sample group in accordance with some embodiments of the disclosure.

In an embodiment, the processor 110 in FIG. 1 selects the target sample group TD2 in FIG. 8 in operation S232, and the processor 110 selects the sample group SD4 in FIG. 6 in operation S234. Then, in operation S236, the processor 110 pastes the target image TI2 of the target sample group TD2 in FIG. 8 to the target area of the image SI4 of the sample group SD4 in FIG. 6 (such as the target area TA as shown in FIG. 9), so as to produce the image MI in the mix sample group MD in FIG. 10.

It should be noted that, the sample group corresponding to the target sample group selected by the processor 110 in operation S232, and the sample group selected by processor 110 in operation S234 must be different sample groups. For example, if the processor 110 selects the target sample group TD2 in FIG. 8 in operation S232, since the sample group TD2 corresponds to the sample group SD2 in FIG. 6, the processor needs to select a sample group other than the sample group SD1 in operation S234.

In some embodiments, after the processor 110 selects the target sample group TD1 in FIG. 8 and the sample group SD4 in FIG. 6, the processor 110 calculates the area of the target image TI2 of the target sample group TD2 and the area of the image SI4 of the sample group SD4. Next, processor 110 calculates the ratio value between the area of the target image TI1 and the area of the image SI4. If the ratio value between the area of the target image TI1 and the area of the image SI4 is not within the ratio value range, the processor 110 re-executes operation S234 to select another sample group.

In some embodiments, In processor 110, before pasting the target image TI2 of the target sample group TD2 in FIG. 8 to the target area of the image SI4 of the sample group SD4 in FIG. 6 (such as the target area TA as shown in FIG. 9), the processor 110 first adjusts at least one of the size and the angle (including the rotation angle) of the target image TI2 according to the adjusting parameter (such as the adjusting parameter P2), so that the area of the adjusted target image (not shown) is the same as the area of the target area TA, or so that the area difference between the area of the adjusted target image (not shown) and the target area TA is within the preset difference range. Then, the processor 110 pastes the adjusted target image to the target area in the image SI4 in the sample group SD4 in FIG. 6 (such as the target area TA as shown in FIG. 9).

In some embodiments, the processor 110 further overlaps the mask TM2 of the target sample group TD2 in FIG. 8 with the mask SM4 of the sample group SD4 in FIG. 6 to produce the mask MM of the mix sample group MD in FIG. 10.

In an embodiment, the processor 110 is further configured to adjust at least one of the size and the angle (including the rotation angle) of the mask TM1 according to the adjusting parameter P2 corresponding to the image MI, and an adjusted mask (not shown) is generated. Then, the processor 110 overlaps the adjusted mask (not shown) with the mask SM4 to generate the mask MM.

Reference is made to FIG. 2 again. In operation S250, several mix sample groups are input to the data augmentation model AM to generate several augmentation mix sample groups.

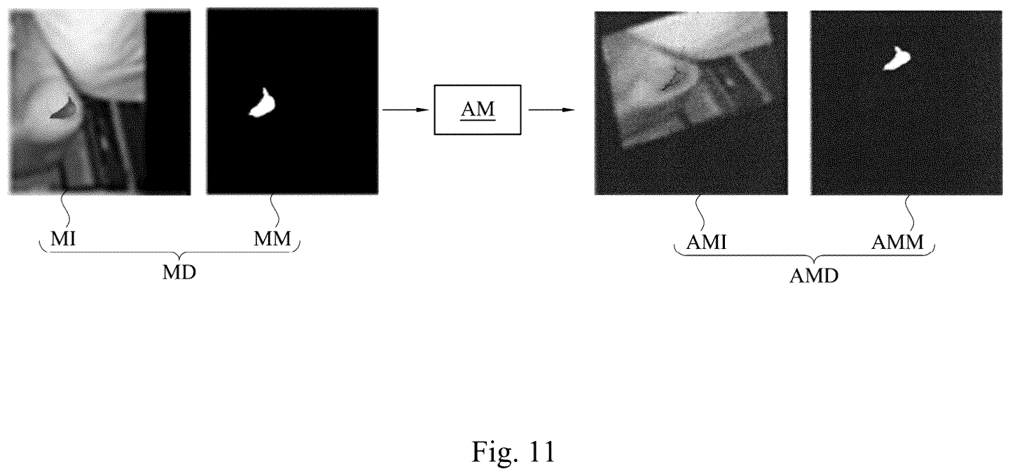

Reference is made to FIG. 11 together. FIG. 11 is a schematic diagram illustrating operation S250 of FIG. 2 in accordance with some embodiments of the disclosure. After the processor 110 inputs the mix sample group MD into the data augmentation model AM as shown in FIG. 1, the augmentation mix sample group AMD is generated. The mix sample group MD includes the image MI and the mask MM corresponding to the image MI. The augmentation mix sample group AMD includes the augmentation image AMI and the augmentation mask AMM corresponding to the augmentation image AMI.

In some embodiments, the data augmentation model AM adjusts at least one of the size, the angle (including the rotation angle), the color and the position of the image MI of the mix sample group MD, so as to generate the augmentation image AMI of the augmentation mix sample group AMD, and data augmentation model AM adjusts the mask MM of the mix sample group MD in correspondence to produce the augmentation mask AMM of the mix sample group MD.

That is, when the image MI of the mix sample group MD is adjusted according to the adjusting parameter P3 (not shown), the augmentation image AMI of the augmentation mix sample group AMD is generated, the data augmentation model AM adjusts the mask MM of the mix sample group MD according to the same adjusting parameter P3 to generate the augmentation mask AMM of the mix sample group MD.

It should be noted that, in FIG. 10 and FIG. 11, only the mix sample group MD and the augmentation mix sample group AMD are used as examples for explanation. More different mix sample groups and augmentation mix sample groups can be generated, which are not explained in detail here.

Reference is made to FIG. 2 again. In operation S270, the segmentation model is trained according to the augmentation sample groups and the augmentation mix sample groups. In some embodiments, operation S270 is performed by the processor 110 in FIG. 1.

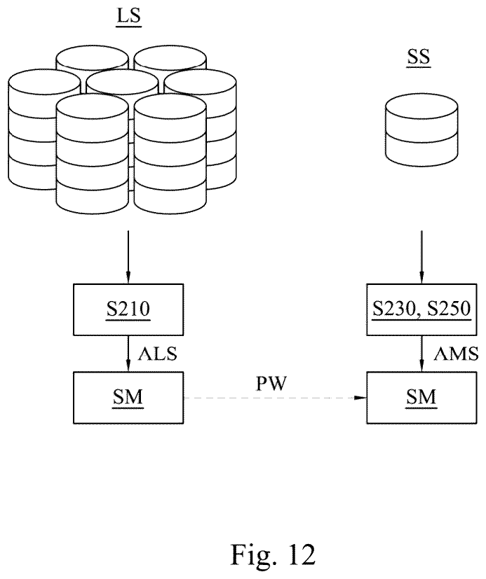

Reference is made to FIG. 12 together. FIG. 12 is a schematic diagram illustrating the operation S270 of FIG. 2 in accordance with some embodiments of the disclosure. As illustrated in FIG. 12, in the embodiments of the present disclosure, the large sample set LS and the small sample set SS are included. After the large sample set LS passes through operation S210 in FIG. 2, the augmentation sample set ALS is generated. The processor 110 as illustrated in FIG. 1 based on augmentation sample set ALS performs pre-training to the segmentation model SM. After the segmentation model SM is pre-trained based on the augmentation sample set ALS, the pre-training parameters PW is generated.

In some embodiments, the large sample set LS is a sample set with a larger number of samples, while small sample set SS is a sample set with a smaller number of samples. In an embodiment, the large sample set LS is a sample set that is public and covers a wider domain, while the small sample set SS is a sample set that is not public and covers a narrower domain.

On the other hand, after the small sample set SS passes through operations S230 and S250 in FIG. 2, the augmentation mix sample set AMS is generated. The augmentation mix sample set AMS includes several augmentation mix sample groups (including, for example, the augmentation mix sample group AMD in FIG. 11). The processor 110 as illustrated in FIG. 1 performs fine-tuning training to the segmentation model SM which includes the pre-training parameters PW based on the augmentation mix sample set AMS.

In summary, the embodiments of the present disclosure provide a segmentation model training method, a segmentation model training device, and a non-transitory computer readable storage medium. By cutting and pasting, the target image of one image of the small sample set is extracted and pasted to the target area of another image of the small sample set to generate a mix sample. When the number of samples is small, more reliable samples can be added to increase the diversity of the small sample set. In addition, by performing augmentation to the mix samples and the large sample sets, the diversity of samples is further increase. Furthermore, when training the segmentation model, the augmentation sample group generated according to the large sample set is first used for pre-training, and then the mix sample group generated according to the mix sample set is used for fine-tuning training. The segmentation model can be effectively trained when the domains between the large sample set and the small sample set are different to solve the problem of a small number of samples in the same domain as the small sample set. Accordingly, in the embodiments of the present invention, when the number of samples in the small sample set is small, after performing pre-training based on the large sample set, fine-tuning training can be performed based on the mix samples generated by the small sample set, and the performance of segmentation model is improved.

It should be noted that, although the above embodiments take skin wounds as an example for description, the embodiments of the present disclosure are not limited to the skin wounds. Various image segmentation training methods (such as image segmentation of damaged electronic devices, etc.) are all within the embodiments of the present disclosure.

The above examples include sequential demonstration operations, but the operations need not be executed in the order shown. Executing the operations in different orders is within the scope of the embodiments of the present disclosure. Within the spirit and scope of the embodiments of the disclosure, the operations may be added, substituted, changed in sequence and/or omitted as appropriate.

Although the present invention has been described in considerable detail with reference to certain embodiments thereof, other embodiments are possible. Therefore, the spirit and scope of the appended claims should not be limited to the description of the embodiments contained herein.

What is claimed is:

1. A segmentation model training method, comprising:
inputting a plurality of first sample groups of a large sample set to a data augmentation model to generate a plurality of augmentation sample groups;
generating a plurality of mix sample groups based on a plurality of second sample groups of a small sample set;
inputting the plurality of mix sample groups to the data augmentation model to generate a plurality of augmentation mix sample groups; and
training a segmentation model according to the plurality of augmentation sample groups and the plurality of augmentation mix sample groups, comprising:
performing pre-training to the segmentation model according to the plurality of augmentation sample groups; and
performing fine-tuning training to the segmentation model corresponding to the plurality of augmentation mix sample groups.

2. The segmentation model training method of claim 1, wherein generating the plurality of mix sample groups based on the plurality of second sample groups of the small sample set comprising:
capturing a target image of a first image based on the first image and a first mask of one of the plurality of second sample groups;
obtaining a target area of a second image based on the second image and a second mask of another one of the plurality of second sample groups; and
pasting the target image to the target area of the second image to generate a third image of one of the plurality of mix sample groups;
wherein a ratio value between an area of the target image and an area of the target area is located within a ratio value range.

3. The segmentation model training method of claim 2, further comprising:
adjusting at least one of a size and an angle of the target image according to an adjusting parameter to generate an adjusted target image, wherein an area of the adjusted target image is the same as an area of the target area;
pasting the adjusted target image to the target area of the second image to generate the third image of the one of the plurality of mix sample groups; and
overlapping the first mask and the second mask to generate a third mask of the one of the plurality of mix sample groups, comprising:
adjusting the first mask according to the adjusting parameter to generate an adjusted mask; and
overlapping the adjusted mask and the second mask to generate the third mask of the one of the plurality of mix sample groups.

4. The segmentation model training method of claim 1, further comprising:
adjusting at least one of a size, an angle, a color, and a position of a plurality of first images of the plurality of mix sample groups according to the data augmentation model to generate a plurality of first augmentation images of the plurality of augmentation mix sample groups;
adjusting at least one of a size, an angle, a color, and a position of a plurality of second images of the plurality of first sample groups according to the data augmentation model to generate a plurality of second augmentation images of the plurality of augmentation sample groups;
adjusting at least one of a size, an angle, a color, and a position of a plurality of first masks of the plurality of mix sample groups corresponding to the plurality of first images of the plurality of mix sample groups to generate a plurality of first augmentation masks of the plurality of augmentation mix sample groups; and
adjusting at least one of a size, an angle, a color, and a position of a plurality of second masks of the plurality of first sample groups corresponding to the plurality of second images of the plurality of first sample groups to generate a plurality of second augmentation masks of the plurality of augmentation sample groups.

5. A segmentation model training device, comprising:
a memory, configured to store a segmentation model and a data augmentation model; and
a processor, coupled to the memory, configured to perform the following operations:
inputting a plurality of first sample groups of a large sample set to a data augmentation model to generate a plurality of augmentation sample groups;
generating a plurality of mix sample groups based on a plurality of second sample groups of a small sample set;
inputting the plurality of mix sample groups to the data augmentation model to generate a plurality of augmentation mix sample groups; and
training the segmentation model according to the plurality of augmentation sample groups and the plurality of augmentation mix sample groups, comprising, comprising:
performing pre-training to the segmentation model according to the plurality of augmentation sample groups; and
performing fine-tuning training to the segmentation model corresponding to the plurality of augmentation mix sample groups.

6. The segmentation model training device of claim 5, wherein the processor is further configured to perform the following operations:
capturing a target image of a first image based on the first image and a first mask of one of the plurality of second sample groups;
obtaining a target area of a second image based on the second image and a second mask of another one of the plurality of second sample groups; and
pasting the target image to the target area of the second image to generate a third image of one of the plurality of mix sample groups;
wherein a ratio value between an area of the target image and an area of the target area is located within a ratio value range.

7. The segmentation model training device of claim 6, wherein the processor is further configured to perform the following operations:
adjusting at least one of a size and an angle of the target image according to an adjusting parameter to generate an adjusted target image, wherein an area of the adjusted target image is the same as an area of the target area;
pasting the adjusted target image to the target area of the second image to generate the third image of the one of the plurality of mix sample groups; and
overlapping the first mask and the second mask to generate a third mask of the one of the plurality of mix sample groups, comprising, comprising:
adjusting the first mask according to the adjusting parameter to generate an adjusted mask; and
overlapping the adjusted mask and the second mask to generate the third mask of the one of the plurality of mix sample groups.

8. The segmentation model training device of claim 5, wherein the processor is further configured to perform the following operations:
adjusting at least one of a size, an angle, a color, and a position of a plurality of first images of the plurality of mix sample groups according to the data augmentation model to generate a plurality of first augmentation images of the plurality of augmentation mix sample groups;
adjusting at least one of a size, an angle, a color, and a position of a plurality of second images of the plurality of first sample groups according to the data augmentation model to generate a plurality of second augmentation images of the plurality of augmentation sample groups;
adjusting at least one of a size, an angle, a color, and a position of a plurality of first masks of the plurality of mix sample groups corresponding to the plurality of first images of the plurality of mix sample groups to generate a plurality of first augmentation masks of the plurality of augmentation mix sample groups; and
adjusting at least one of a size, an angle, a color, and a position of a plurality of second masks of the plurality of first sample groups corresponding to the plurality of second images of the plurality of first sample groups to generate a plurality of second augmentation masks of the plurality of augmentation sample groups.

9. A non-transitory computer readable storage medium, configured to store a computer program, wherein when the computer program is executed, one or more processors are executed to perform a plurality of operations, wherein the plurality of operations comprise:
inputting a plurality of first sample groups of a large sample set to a data augmentation model to generate a plurality of augmentation sample groups;
generating a plurality of mix sample groups based on a plurality of second sample groups of a small sample set;
inputting the plurality of mix sample groups to the data augmentation model to generate a plurality of augmentation mix sample groups; and
training a segmentation model according to the plurality of augmentation sample groups and the plurality of augmentation mix sample groups, comprising:
performing pre-training to the segmentation model according to the plurality of augmentation sample groups; and
performing fine-tuning training to the segmentation model corresponding to the plurality of augmentation mix sample groups.

10. The non-transitory computer readable storage medium of claim 9, wherein the plurality of operations further comprising:
capturing a target image of a first image based on the first image and a first mask of one of the plurality of second sample groups;
obtaining a target area of a second image based on the second image and a second mask of another one of the plurality of second sample groups; and
pasting the target image to the target area of the second image to generate a third image of one of the plurality of mix sample groups.
